(19) United States
(12) Patent Application Publication
(10) Pub. No.: US 2013/0132708 A1
(43) Pub. Date: May 23, 2013

(54) MULTI-CORE PROCESSOR SYSTEM, COMPUTER PRODUCT, AND CONTROL METHOD

(71) Applicant: FUJITSU LIMITED, Kawasaki-shi (JP)

(72) Inventors: Koji Kurihara, Kawasaki (JP); Koichiro Yamashita, Hachioji (JP); Hiromasa Yamauchi, Kawasaki (JP); Takahisa Suzuki, Kawasaki (JP)

(73) Assignee: FUJITSU LIMITED, Kawasaki-shi (JP)

(21) Appl. No.: 13/748,132

(22) Filed: Jan. 23, 2013

Related U.S. Application Data
(63) Continuation of application No. PCT/JP2010/062629, filed on Jul. 27, 2010.

(51) Int. Cl. G06F 15/80

(52) U.S. Cl. CPC G06F 15/80
USPC 712/42

(57) ABSTRACT

A multi-core processor system includes a first core that is of a multi-core processor and configured to detect preprocessing for access of shared resources by a second core that is of the multi-core processor excluding the first core, when the first core is accessing the shared resources shared by the multi-core processor; and switch a task being executed by the second core to another task upon detecting the preprocessing.

### CROSS REFERENCE TO RELATED APPLICATIONS

This application is a continuation application of International Application PCT/JP2010/062629, filed on Jul. 27, 2010 and designating the U.S., the entire contents of which are incorporated herein by reference.

### FIELD

The embodiments discussed herein are related to a multi-core processor system, a computer product, and a control method that control access of shared resources.

### BACKGROUND

Conventionally, tasks such as tasks related to rendering processing, frequently access memory at the end of execution (see, e.g., Japanese Laid-Open Patent Publication No. 2008-130091). Rendering process refers to, for example, making a drawing based on physical properties of light by specifying the location and the direction of a camera and a light source relative to a three-dimensional object.

In a multi-core processor system having memory shared by multi-core processors, for example, the rendering process is divided into plural tasks to perform distributed processing and at the end of each of the tasks, computation results stored in a cache of each central processing unit (CPU) has to be written back to the shared memory.

In the multi-core processor system, however, the tasks of the rendering process are allocated to the CPUs in such a manner that task volume is averaged with consideration of load balance. For this reason, the CPUs finish the processing simultaneously and consequently contend for access of the shared memory at the time of finishing of the processing of the tasks.

When access of the shared memory occurs simultaneously by plural CPUs, an arbiter circuit arbitrates the access from which CPU should be permitted. The arbiter circuit performs arbitration using, for example, a round-robin method of giving access privilege to the CPUs in turn. With the arbiter circuit arbitrating access of the shared memory, the memory access performance at the time of access contention with respect to the shared memory can be 30[%] of the peak and thus, there is a problem of reduced effective performance of each CPU. The memory access performance refers to the time required for each CPU to access the shared memory.

### SUMMARY

According to an aspect of an embodiment, a multi-core processor system includes a first core that is of a multi-core processor and configured to detect preprocessing for access of shared resources by a second core that is of the multi-core processor excluding the first core, when the first core is accessing the shared resources shared by the multi-core processor; and switch a task being executed by the second core to another task upon detecting the preprocessing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of one example of the present invention;

FIG. 2 is an explanatory diagram of another example of the present invention;

FIG. 3 is a block diagram of a hardware example of a multi-core processor system;

FIG. 4 is an explanatory diagram of one example of an attribute table 400;

FIG. 5 is an explanatory diagram of one example of large-volume access start information 500;

FIG. 6 is a functional block diagram of a multi-core processor system 300;

FIG. 7 is an explanatory diagram of an example of task 2 being dispatched to CPU#0;

FIG. 8 is an explanatory diagram of an example of task 5 being dispatched to CPU#1;

FIG. 9 is an explanatory diagram of an example of task 7 being dispatched to CPU#2;

FIG. 10 is an explanatory diagram of an example of the CPU#0 starting large-volume access;

FIG. 11 is an explanatory diagram of a detection example of large-volume access by the CPU#1;

FIG. 12 is an explanatory diagram of an example of task dispatching by the CPU#1;

FIGS. 13 and 14 are flowcharts of one example of control processing by a scheduler 351; and

FIG. 15 is a flowchart of control processing by an attribute changer 371.

### DESCRIPTION OF EMBODIMENTS

A preferred embodiment of a multi-core processor system, a control program, and a control method according to the present invention will be described in detail with reference to the accompanying drawings.

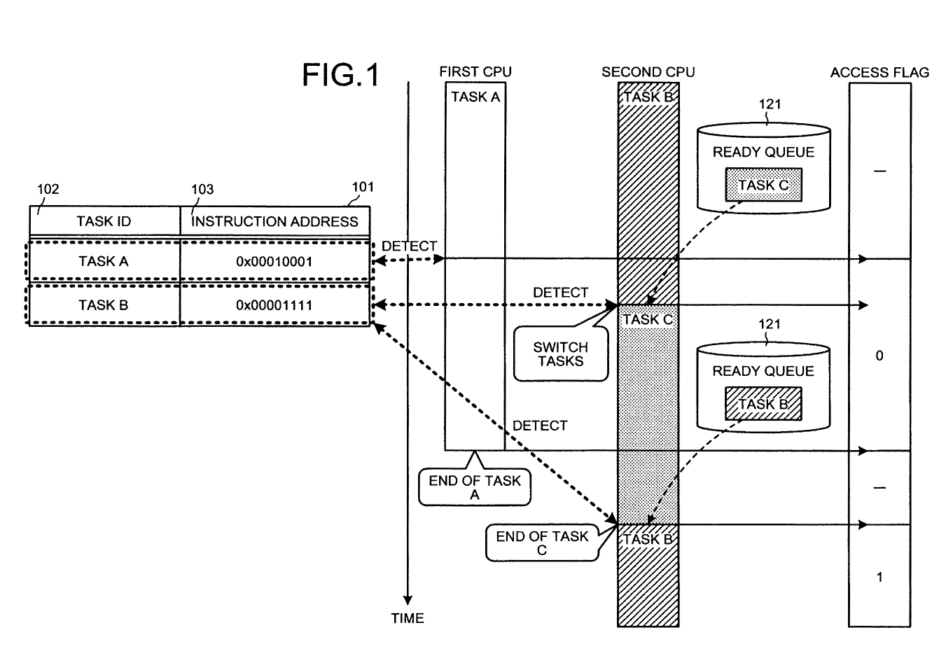

FIG. 1 is an explanatory diagram of one example of the present invention. A first CPU is executing task A and a second CPU is executing task B. Task C is stacked in a ready queue 121 of the second CPU. As is commonly known, to manage a task in a ready condition among tasks allocated to the second CPU, the ready queue 121 holds context information of the task. Thus, by obtaining the context information registered in the ready queue 121, the second CPU can execute the task. The context information is the information indicating the internal state of a program and where in the memory the program is located.

A table 101 has a task ID field 102 and an instruction address field 103. The table 101 holds for each task, the address of an instruction to access the shared memory of the first CPU and the second CPU. The shared memory is an example of resources shared in the multi-core processor composed of the first CPU and the second CPU.

An access flag is information that indicates which CPU is the first to have accessed the shared memory. For example, when the value of the access flag is 0, the first CPU is accessing the shared memory. When the value of the access flag is 0, the value of the access flag indicates the state of the first CPU. For example, a value of 1 indicates that the second CPU is accessing the shared memory. Thus, when the value of the access flag is 1, the value indicates the state of the second CPU. Further, for example, when the value of the access flag is −, the value indicates that neither the first CPU nor the second CPU is accessing the shared memory.

The first CPU, for example as access preprocessing, detects matching of a program counter of the first CPU and the address of the instruction for accessing the shared memory by task A, held in the table 101. The first CPU checks the access flag and determines whether the value of the access flag is “−”. Since the value of the access flag is −, the first CPU sets the access flag to 0.

Then, the second CPU, for example as access preprocessing, detects the matching of the program counter of the second CPU and the address of the instruction for accessing the shared memory by task B, held in the table 101. The second CPU checks the access flag and determines whether the value of the access flag is −. Since the value of the access flag is 0, the second CPU, upon determining that the first CPU is accessing the shared memory, switches from task B to task C in the ready queue 121.

Upon finishing of execution of task A, the first CPU sets the value of the access flag to −. Then, upon finishing of task C, the second CPU obtains task B from the ready queue 121 and executes task B. The second CPU detects, as access preprocessing, the matching of the program counter of task B and the address of the instruction for accessing the shared memory by task B, held in the table 101.

Upon detection of the preprocessing, the second CPU checks the access flag and determines whether the value of the access flag is −. Further, since the value of the access flag is −, the second CPU sets the access flag to 1 and causes task B to start accessing the shared memory.

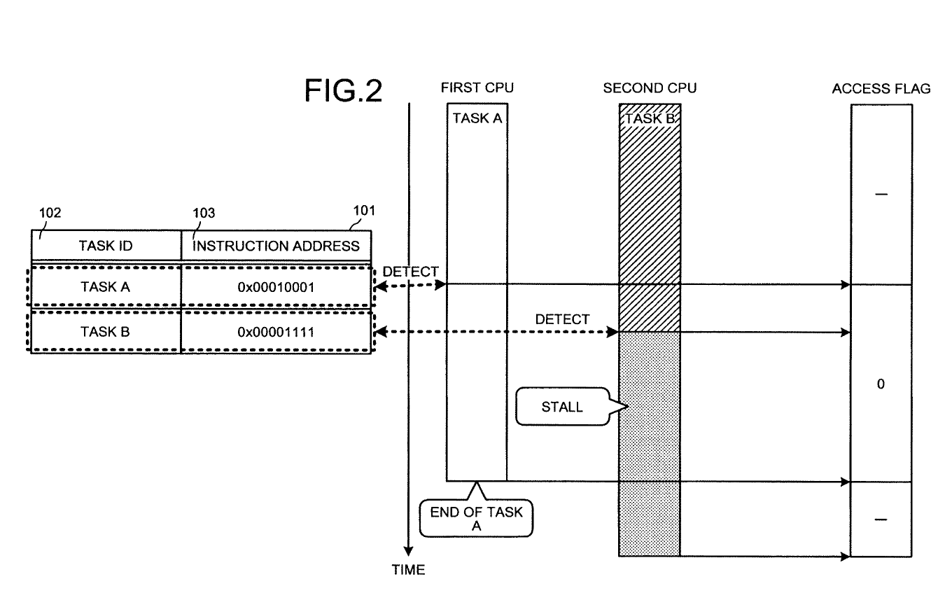

FIG. 2 is an explanatory diagram of another example of the present invention. Firstly, the first CPU detects, as preprocessing of access, the matching of the program counter of the first CPU and the address of the instruction for accessing the shared memory by task A, held in the table 101. The first CPU then checks the access flag and determines whether the value of the access flag is −. Since the value of the access flag is −, the first CPU sets the access flag to 0.

Then, the second CPU detects, as preprocessing of access, the matching of the program counter of the second CPU and the address of the instruction for the access to the shared memory by task B, held in the table 101. The second CPU then checks the access flag and determines whether the value of the access flag is −. Since the value of the access flag is 0, the second CPU, upon determining that the first CPU is accessing the shared memory, stalls task B.

Upon the completion of execution of task A, the first CPU sets the value of the access flag to −. Although not illustrated, for example, the second CPU may detect the completion of execution of task A and restart processing task B. Alternatively, for example, the second CPU may restart processing task B in the ready queue and register other task on the ready queue, if other task has been newly allocated to the second CPU.

Since the table 101 depicted in FIGS. 1 and 2 holds only one instruction address for each task, attention is focused only on an interval from the instruction address until the end of the task. Namely, the interval from processing to be executed at the instruction address until the end of the task is treated as one access. Design is not limited hereto and the table 101 may register, for example, a start instruction address of each access to the shared memory by task A to an end instruction address of the access. Namely, the interval from the processing to be executed at the start instruction address until the processing to be executed at the end instruction address is treated as one access. The first CPU may set the access flag so that each access of the shared memory by task A to be executed in the first CPU will not conflict with the access of the shared memory by task B to be executed in the second CPU.

In this embodiment, an example is given of plural CPUs that do not contend for access when the volume of access is greater than or equal to a predetermined volume. When the volume of access is greater than or equal to a predetermined volume is when access density (number of times of memory access per unit time) exceeds a given threshold. An application designer measures the access time in the case of access contention and the access time in the case of a non-access contention while changing the access density.

The volume of access at which the access time in the case of the non-access contention (tasks accessing memory sequentially) becomes smaller than the access time in the case of the access contention is determined as the predetermined access volume (threshold). It is assumed that access by each task whose volume of access is greater than or equal to the predetermined access volume is preliminarily measured. Large-volume access is when the memory access density during task processing exceeds the predetermined access volume.

Here, the access times for a case of access contention and for a case of no access contention are compared. Memory access performance at the time of the access contention is said to drop to about 30[%] of that in a case of no access contention. As described, when access contention arises among CPUs conflict, the arbiter circuit arbitrates the access privilege. Consequently, when there is access contention, the access time increases consequent to the arbitration time, switching of the access privilege, etc.

The access data size per unit time in the case of no access contention is given as X. With consideration of the memory access performance at the time of access contention dropping to about 30[%] of that in the case of no access contention, the access data size per unit time at the time of access contention becomes 0.3X. The time required for accessing data of Y size by the first CPU and the second CPU is obtained as follows:

In the case of no access contention (in the case of accessing memory sequentially): Time S=Y/X+Y/X=2Y/X In the case of the access contention (in the case of accessing memory simultaneously): Time P=Y/0.3X=3.3Y/X

Namely, the access time in the case of access contention is 1.65 times (P/S) as much as the access time in the case of no access contention.

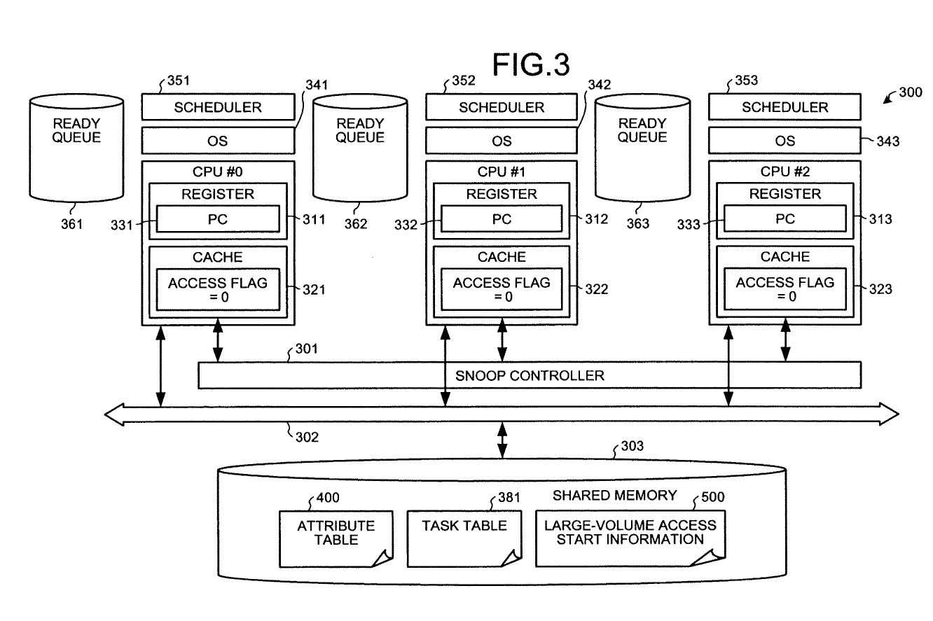

FIG. 3 is a block diagram of a hardware example of the multi-core processor system. A multi-core processor system 300 has CPU#0 to CPU#2, a shared memory 303, and a snoop controller 301.

Each of the CPU#0 to the CPU#2 has, for example, a core, a register, and a cache. A register 311 of the CPU#0 has a program counter (PC) 331, a register 312 of the CPU#1 has a PC 332, and a register 313 of the CPU#2 has a PC 333.

The CPU#0 executes an OS 341 as a master OS and is in charge of overall control of the multi-core processor system 300. The OS 341 controls to which CPU each process of software should be allocated and has a scheduler 351 as a control program to control the switching of tasks in the CPU#0. A ready queue 361 holds the context information of the task in the ready condition, among the tasks allocated to the CPU#0.

The CPU#1 and the CPU#2 execute an OS 342 and an OS 343 as slave OSs, respectively. The OS 342 has a scheduler 352 as the control program to control the switching of the tasks allocated to the CPU#1. A ready queue 362 holds the context information of the task in the ready condition among the tasks allocated to the CPU#1. The OS 343 has a scheduler 353 as the control program to control the switching of the tasks allocated to the CPU#2. A ready queue 363 holds the context information of the task in the ready condition among the tasks allocated to the CPU#2.

The CPU#0 has a cache 321, the CPU#1 has a cache 322, and the CPU#2 has a cache 323. The caches are connected to one another by way of the snoop controller 301. The cache of each CPU detects updating of shared data such as the access flag by monitoring the line state of itself and the caches of other cores and exchanging information of the updating state with the caches of other cores. Upon detection of the updating, each cache purges non-updated data and caches the updated data.

The access flag held by each cache is shared data shared by the caches and the access flag is information indicating which CPU has accessed the shared memory 303 first. For example, when the access flag is 0, the access flag indicates that the CPU#0 is performing the large-volume access to the shared memory 303. When the value of the access flag is 0, the value of the access flag is a value indicative of the CPU#0. For example, when the access flag is 1, the access flag indicates that the CPU#1 is performing the large-volume access to the shared memory 303. When the value of the access flag is 1, the value of the access flag is a value indicative of the CPU#1. When the access flag is 2, the access flag indicates that the CPU#2 is performing large-volume access of the shared memory 303. When the value of the access flag is 2, the value of the access flag is a value indicative of the CPU#2. When the value of the access flag is −, the access flag indicates that none of the CPUs are accessing the shared memory 303.

Each CPU and the shared memory 303 are connected by way of a bus 302. The shared memory 303 is, for example, memory shared by the multi-core processor. The shared memory 303 has, for example, an attribute table 400, a task table 381, large-volume access start information 500, a boot program, application software, and the OS 341 to the OS 343.

For example, the shared memory 303 has, for example, a read only memory (ROM), a random access memory (RAM), a flash ROM, etc. For example, the flash ROM stores the boot program, the ROM stores the application program, and the RAM is used as a work area of the CPU#0 to the CPU#2. The programs stored in the shared memory 303, by being loaded to the CPUs, cause the CPUs to execute coded processing.

The task table 381 is information indicating to which CPU, a process or a function of the software is allocated and the process or the function of which software each CPU is executing.

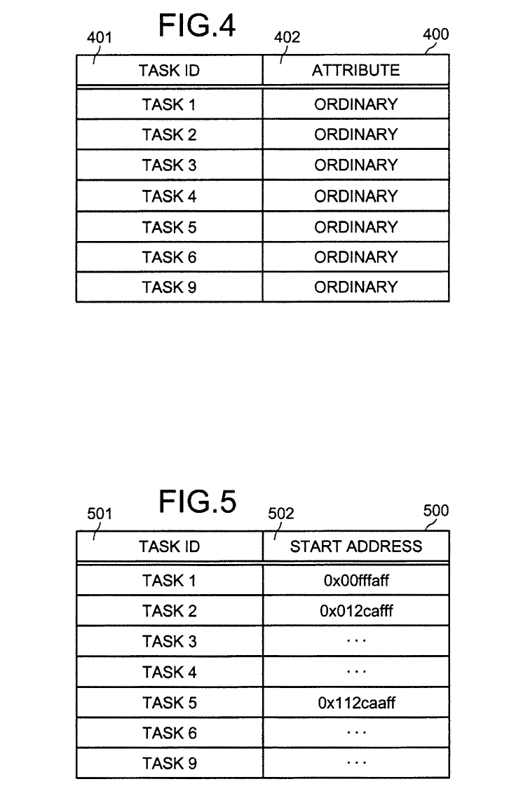

FIG. 4 is an explanatory diagram of one example of the attribute table 400. The attribute table 400 describes an attribute of each task. The attribute table 400 has a task ID field 401 and an attribute field 402. The task ID field 401 holds the name of each task and the attribute field 402 holds an attribute of each task. The attribute field 402 holds any one among “access” and “ordinary”. “access” indicates the state of a task performing the large-volume access of the shared memory 303 and “ordinary” indicates the state of a task not performing the large-volume access of the shared memory 303.

It is assumed that a task whose task name is not held in the task ID field 401 is a task whose attribute is not yet appended. In this embodiment, if the tasks include task 1 to task 9, tasks 1 to 6 and task 9 are tasks whose attribute is appended and task 7 and task 8 are tasks whose attribute is not yet appended.

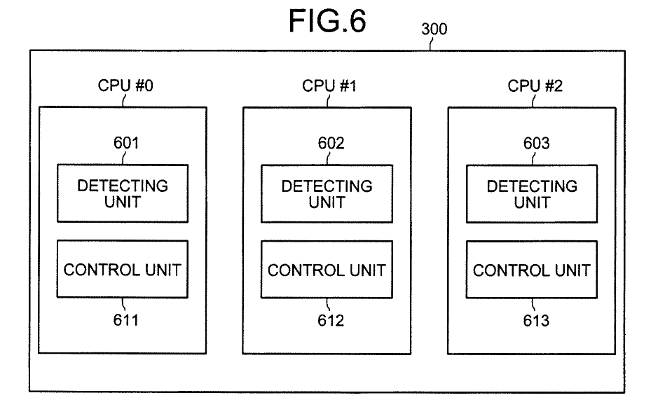

FIG. 5 is an explanatory diagram of one example of large-volume access start information 500. The large-volume access start information 500 is a table holding the instruction address for transitioning to the large-volume access state for each task ID of the task.

The large-volume access start information 500 has a task ID field 501 and a start address field 502. The task ID field 501 holds the names of tasks. The start address field 502 holds the instruction address for transitioning to the large-volume access state.

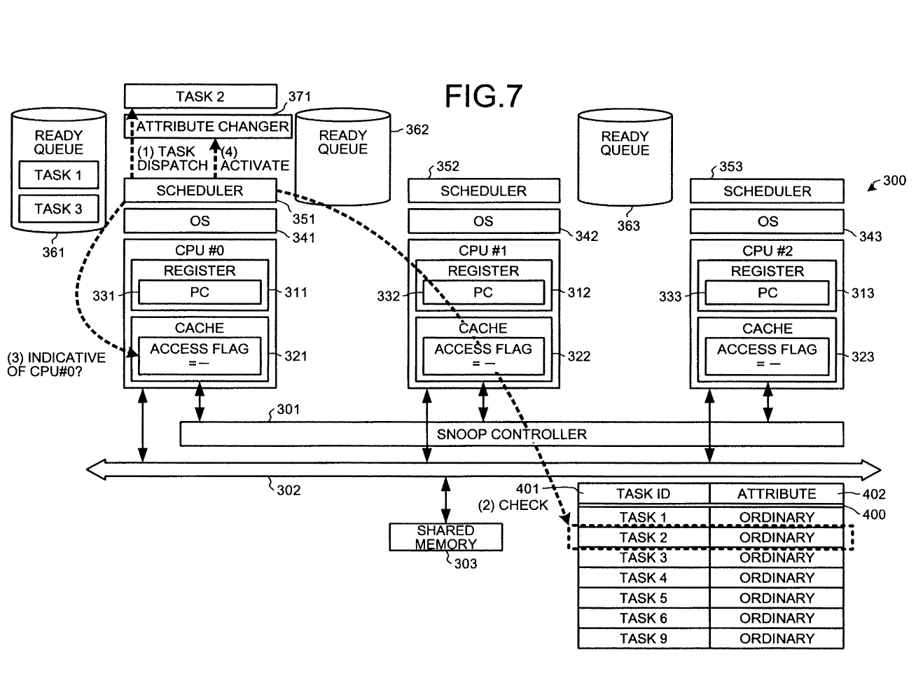

FIG. 6 is a functional block diagram of the multi-core processor system 300. The multi-core processor system 300 has detecting units 601, 602, and 603 and control units 611, 612, and 613.

The detecting units 601, 602, and 603 are stored in a memory device as a program called an attribute changer to be described later. Each CPU loads the attribute changer from the memory device and executes the processing coded in the attribute changer.

The control units 611, 612, and 613 are stored in the memory device as the scheduler 351, the scheduler 352, and the scheduler 353, respectively. Each CPU loads the corresponding scheduler from the memory device and executes the processing coded in the scheduler. Description will be made citing an example of the detecting unit 601 and the control unit 611 that run on the CPU#0.

When a given core of the multi-core processor and excluding the CPU#0 executing the detecting unit 601, is accessing resources shared by the multi-core processor, the detecting unit 601 detects the preprocessing of the access of the shared resources by the CPU#0.

In the case of detection of the preprocessing by the detecting unit 601, the control unit 611 switches the task being executed in the CPU#0 to another given task.

In the case of detection of the preprocessing by the detecting unit 601, the control unit 611 stalls the task under execution by the CPU#0.

When the volume of access of the shared resources by the given core is greater than or equal to a predetermined volume, the detecting unit 601 detects the preprocessing of the access of the shared resources by the CPU#0. The predetermined volume is the predetermined access volume described above.

When the given core is accessing the shared resources, the detecting unit 601 detects access preprocessing when the volume of access of the shared resources by the CPU#0 is greater than or equal to the predetermined volume.

Since the detecting unit 602 and the control unit 612 that operate on the CPU#1 and the detecting unit 603 and the control unit 611 that operate on the CPU#2 performs the same processing as that of the detecting unit 601 and the control unit 611 that operate on the CPU#0, description thereof is omitted.

In light of the above, detailed description will be made with reference to the drawings.

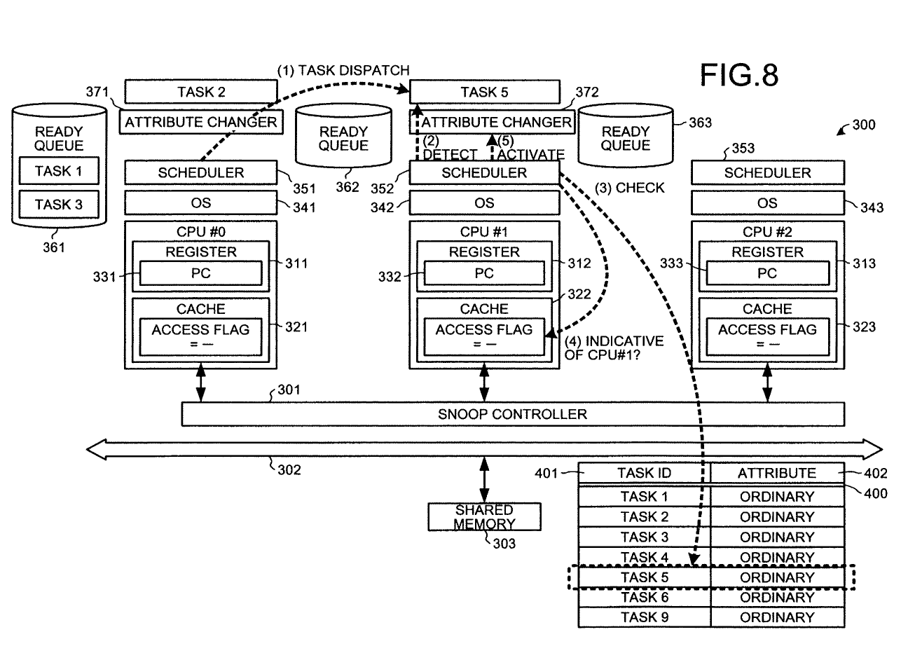

FIG. 7 is an explanatory diagram of an example of task 2 being dispatched to the CPU#0. Firstly, the scheduler 351 (1), by dispatching task 2 to the CPU#0, detects the dispatch of the task to the CPU#0. The scheduler 351 (2) checks the attribute of the dispatched task 2 by acquiring the attribute of task 2 from the attribute table 400.

Since the attribute of task 2 is “ordinary”, the scheduler 351 (3) determines if the value of the access flag is a value indicative of the CPU#0. Since the value of the access flag is −, which indicates none of the CPUs, the scheduler 351 determines if an attribute changer 371 is already activated. Since the attribute changer 371 is not yet activated, the scheduler 351 (4) activates the attribute changer 371.

The attribute changer 371, when activated by the scheduler 351, acquires the instruction address for transitioning task 2 under execution, to the large-volume access state. The attribute changer 371 compares the acquired instruction address and the value of the PC 331 of the CPU#0 and thereby, monitors the start of the large-volume access by task 2.

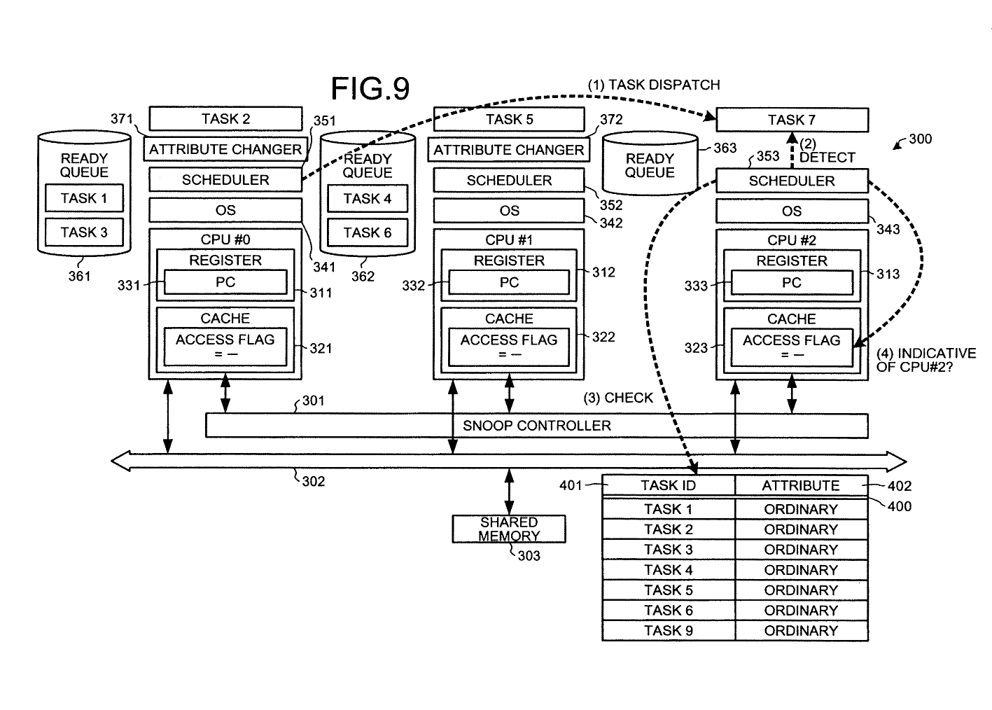

FIG. 8 is an explanatory diagram of an example of task 5 being dispatched to the CPU#1. Task 1 and task 3 are stacked in the ready queue 361 of the CPU#0. When the scheduler 351 (1) dispatches task 5 to the CPU#1, the scheduler 352 (2) detects the dispatch.

The scheduler 352 (3) checks the attribute of the dispatched task 5 by acquiring the attribute of task 5 from the attribute table 400. Since the attribute of task 5 is “ordinary”, the scheduler 352 (4) determines if the value of the access flag is a value indicative of the CPU#1. Since the value of the access flag is −, which indicates none of the CPUs, the scheduler 352 determines if the attribute changer 372 is already activated. Since the attribute changer 372 is not yet activated, the scheduler 352 (5) activates the attribute changer 372.

The attribute changer 372, when activated by the scheduler 352, acquires the instruction address for transitioning task 5 under execution, to the large-volume access state. The attribute changer 372 compares the acquired instruction address and the value of the PC 332 of the CPU#1 and thereby, monitors the start of the large-volume access by task 5.

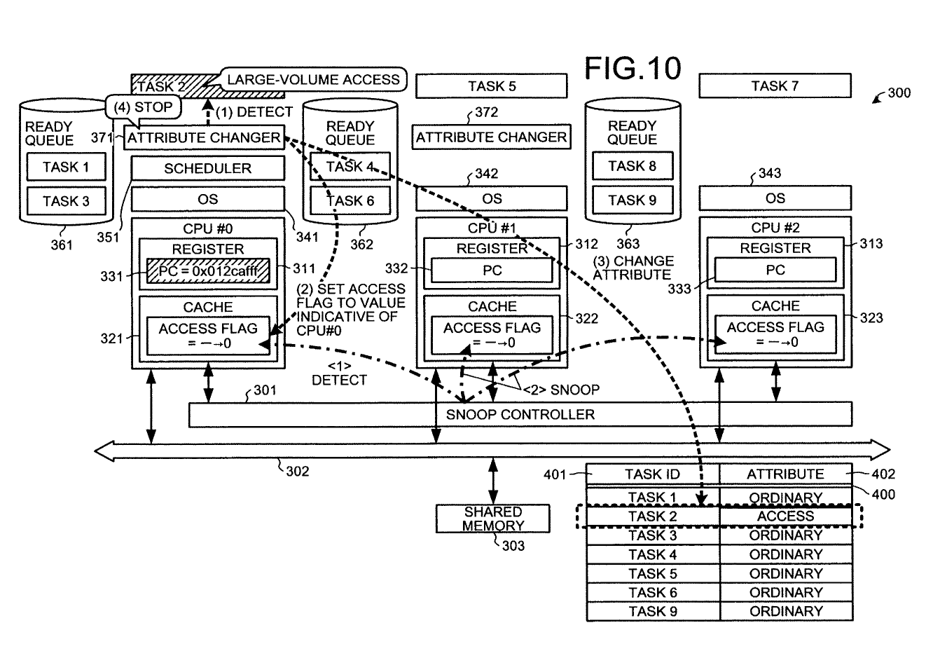

FIG. 9 is an explanatory diagram of an example of task 7 being dispatched to the CPU#2. Task 4 and task 6 are stacked in the ready queue 362 of the CPU#1. When the scheduler 351 (1) dispatches task 7 to the CPU#2, the scheduler 353 (2) detects the dispatch.

The scheduler 353 (3) checks the attribute of the dispatched task 7 by acquiring the attribute of task 7 from the attribute table 400. Since the attribute of task 7 is not registered in the attribute table 400, the attribute is not yet appended. The scheduler 353 (4) determines whether the value of the access flag is a value indicative of the CPU#2. The value of the access flag is −, which indicates none of the CPUs. The scheduler 353 determines if the attribute changer is already activated. The attribute changer is not yet activated and the scheduler 353 does not activate the attribute changer.

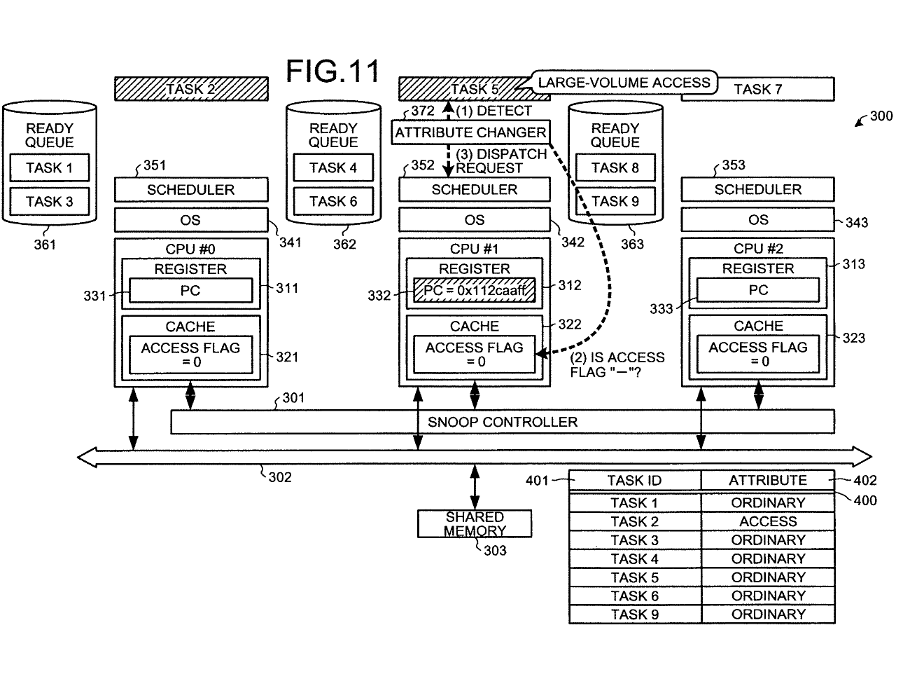

FIG. 10 is an explanatory diagram of an example of the CPU#0 starting large-volume access. As described, the attribute changer 371 compares the acquired instruction address and the value of the PC 331 of the CPU#0 and thereby, monitors the start of large-volume access by task 2. The attribute changer 371 (1) detects access preprocessing for when the volume of access of the shared memory 303 is greater than or equal to the predetermined volume by detecting the matching of the acquired instruction address and the value of the PC 331 of the CPU#0.

The attribute changer 371 (2) sets the access flag at the value indicative of the CPU#0. The attribute changer 371 then (3) changes the attribute field 402 corresponding to task 2 held as the task ID field 401 in the attribute table 400 from “ordinary” to “access”. The attribute changer 371 then (4) stops the attribute changer 371.

The snoop controller 301, <1> upon detection of the change of the access flag in the cache 321 of the CPU#0, <2> updates the access flag in the cache 322 of the CPU#1 and the cache 323 of the CPU#2 by snooping. An address space of the access flag is always arranged on the cache of all CPUs. For example, a locked area is reserved on the cache of all CPUs and the address space of the access flag is arranged in the locked area.

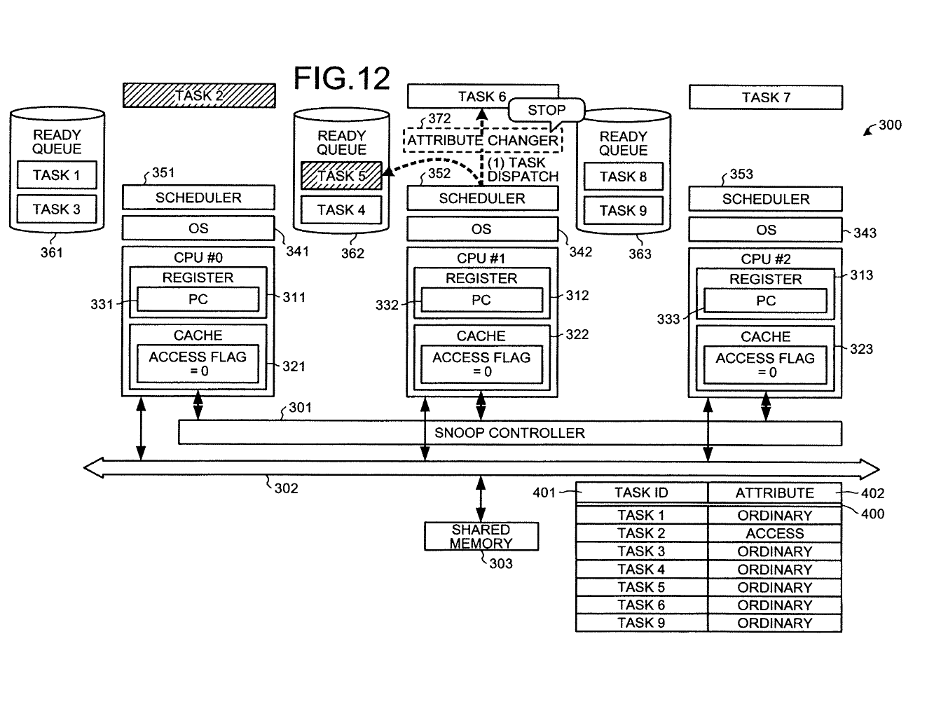

FIG. 11 is an explanatory diagram of a detection example of large-volume access by the CPU#1. As described, the attribute changer 372 compares the acquired instruction address and the value of the PC 332 of the CPU#1 and thereby, monitors the start of large-volume access by task 5. The attribute changer 372, by the detecting unit 602, (1) detects access preprocessing when the volume of access of the shared memory 303 is greater than or equal to the predetermined volume, by detecting the matching of the acquired instruction address and the value of the PC 332 of the CPU#1.

The attribute changer 372 (2) determines if the access flag is −. Since the access flag is 0, the attribute changer 372 (3) notifies the scheduler 352 of a request to dispatch another task.

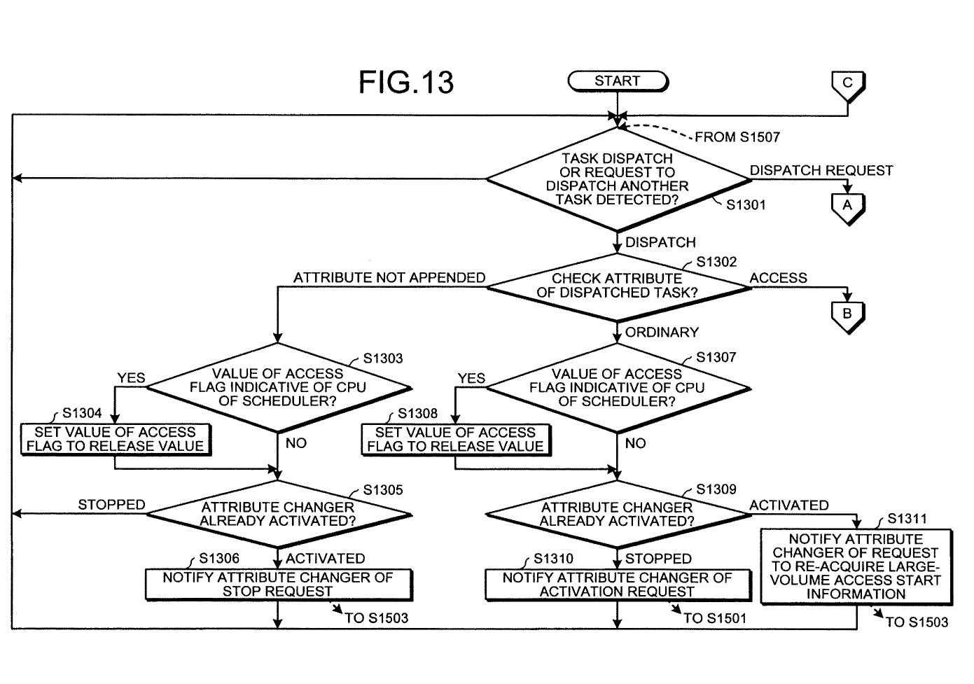

FIG. 12 is an explanatory diagram of an example of task dispatching at the CPU#1. Upon receipt of the request to dispatch, the scheduler 352, by the control unit 612, (1) dispatches task 6 in place of task 5. The attribute changer 372 stops.

The scheduler 352, by dispatching task 6, detects the dispatch of task 6 and the scheduler 352 performs the same processing as in the case of the dispatch of task 5 as depicted in FIG. 8.

In this embodiment, an example of plural CPUs that not contend for access when the volume of access is greater than or equal to the predetermined volume is described. However configuration is not limited hereto and, for example, configuration may be such that when one CPU is accessing the shared memory 303 irrespective of large-volume access or otherwise, access preprocessing when the volume of access of the shared memory 303 by another CPU is greater than or equal to the predetermined volume is detected and access contention is prevented. For example, configuration may be such that, when one CPU is accessing the shared memory 303 at a volume greater than or equal to the predetermined volume, access preprocessing of another CPU with respect to the shared memory 303, irrespective of large-volume access or otherwise, is detected and access contention is prevented.

A procedure will be described of control processing by the multi-core processor system 300. While description will be made giving an example of the scheduler 351 and the attribute changer 371 operating in the CPU#0, the processing is the same with the scheduler and the attribute changer operating in the other CPUs.

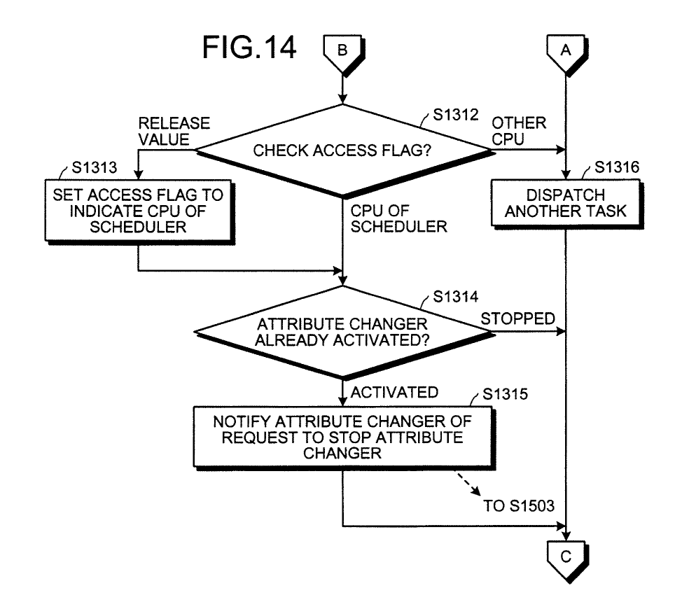

FIGS. 13 and 14 are a flowchart of one example of control processing by the scheduler 351. The scheduler 351 determines if task dispatch or a request to dispatch another task is detected (step S1301). If the scheduler 351 determines that neither task dispatch nor a request to dispatch another task is detected, the flow returns to step S1301.

If the scheduler 351 determines that task dispatch is detected (step S1301: DISPATCH), the scheduler 351 checks the attribute of the dispatched task (step S1302). If the scheduler 351 determines that the attribute of the dispatched task is not yet appended (step S1302: ATTRIBUTE NOT APPENDED), the scheduler 351 determines if the value of the access flag is a value indicative of the CPU of the scheduler 351 (step S1303).

If the scheduler 351 determines that the value of the access flag is a value indicative of the CPU of the scheduler 351 (step S1303: YES), the scheduler 351 sets the value of the access flag to a release value (step S1304). Here, “−” is referred to as the release value. If the scheduler 351 determines that the value of the access flag is not a value indicative of the CPU of the scheduler 351 (step S1303: NO) or as a step after step S1304, the scheduler 351 determines if the attribute changer 371 is already activated (step S1305).

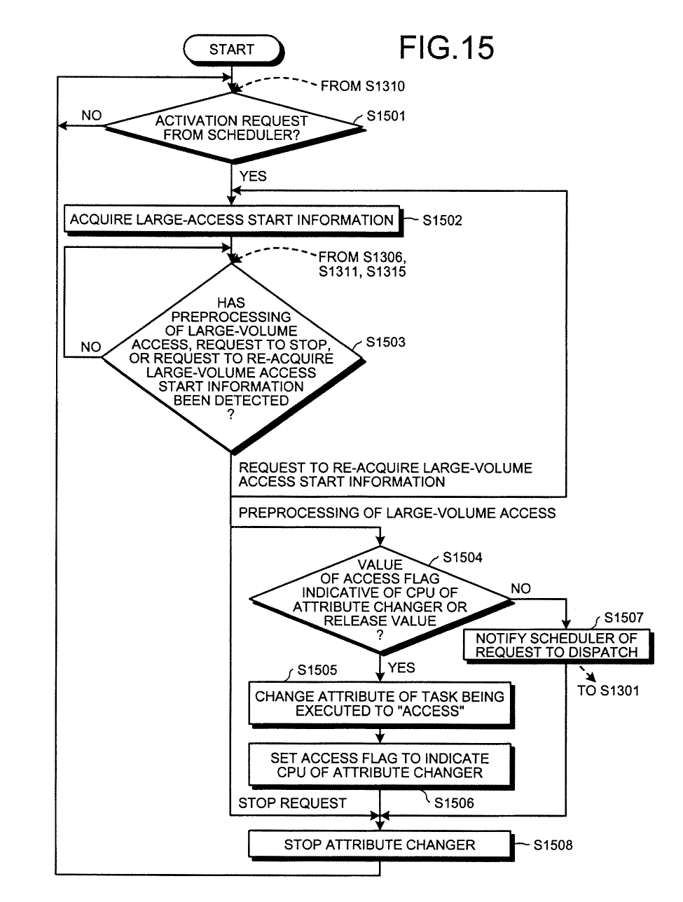

If the scheduler 351 determines that the attribute changer 371 is already activated (step S1305: YES), the scheduler 351 notifies the attribute changer 371 (to step S1503 of FIG. 15) of a request to stop the attribute changer 371 (step S1306). After step S1306, the flow returns to step S1301. On the other hand, if the scheduler 351 determines that the attribute changer 371 is not activated (step S1305: STOPPED), the flow returns to step S1301.

If the scheduler 351 determines that the attribute of the dispatched task is “ordinary” (step S1302: ORDINARY), the scheduler 351 determines if the value of the access flag is a value indicative of the CPU of the scheduler 351 (step S1307). If the scheduler 351 determines that the value of the access flag is a value indicative of the CPU of the scheduler 351 (step S1307: YES), the scheduler 351 sets the value of the access flag to the release value (step S1308). If the scheduler 351 determines that the value of the access flag is not a value indicative of the CPU of the scheduler 351 (step S1307: NO) or as a step after step S1308, the scheduler 351 determines if the attribute changer 371 is already activated (step S1309).

If the scheduler 351 determines that the attribute changer 371 is not yet activated (step S1309: STOPPED), the scheduler 351 notifies the attribute changer 371 (to step S1501) of a request to activate (step S1310). If the scheduler 351 determines that the attribute changer 371 is already activated (step S1309: ACTIVATED), the scheduler 351 notifies the attribute changer 371 (to step S1503 of FIG. 15) of a request to re-acquire the large-volume access start information 500 (step S1311). After step S1310 or step S1311, the flow returns to step S1301.

At step S1301, if the scheduler 351 determines that a request to dispatch another task is detected (step S1301: DISPATCH REQUEST), the scheduler 351, by the control unit 611, dispatches another task in the ready queue 361 (step S1316).

At step S1302, if the scheduler 351 determines that the attribute of the dispatched task is “access” (step S1302: ACCESS), the scheduler 351 checks the access flag (step S1312). If the scheduler 351 determines that the value of the access flag is a release value (step S1312: RELEASE VALUE), the scheduler 351 sets the value of the access flag to a value indicative of the CPU of the scheduler 351 (step S1313).

If the scheduler 351 determines that the access flag is indicative of the CPU of the scheduler 351 (step S1312: CPU OF SCHEDULER) or as a step after step S1313, the scheduler 351 determines if the attribute changer 371 is already activated (step S1314). If the scheduler 351 determines that the attribute changer 371 is already activated (step S1314: ACTIVATED), the scheduler 351 notifies the attribute changer 371 (to step S1503 of FIG. 15) of the request to stop the attribute changer 371 (step S1315).

At step S1312, if the scheduler 351 determines that the access flag is indicative of another CPU (step S1312: OTHER CPU), the scheduler 351 proceeds to step S1316. At step S1314, if the scheduler 351 determines that the attribute changer 371 is not activated (step S1314: STOPPED) or as a step after step S1315 or step S1316, the flow returns to step S1301.

FIG. 15 is a flowchart of control processing by the attribute changer 371. The attribute changer 371 determines if there is a request to active from the scheduler 351 (step S1501) and if the attribute changer 371 determines that there is no request to active, from the scheduler 351 (step S1501: NO), the flow returns to step S1501. If the attribute changer 371 determines that there is a request to active, from the scheduler 351 (step S1501: YES), the attribute changer 371 acquires the large-access start information 500 (step S1502).

The attribute changer 371 determines if any among the preprocessing of large-volume access, a request to stop, and a request to re-acquire the large-volume access start information 500 has been detected (step S1503). If the attribute changer 371 determines that none among the preprocessing of large-volume access, a request to stop, and a request to re-acquire the large-volume access start information 500 has been detected (step S1503: NO), the flow returns to step S1503.

If the attribute changer 371 determines that a request to re-acquire the large-volume access start information 500 has been detected (step S1503: REQUEST TO RE-ACQUIRE LARGE-VOLUME ACCESS START INFORMATION), the flow returns to step S1502. If the attribute changer 371, by the detecting unit 601, determines that preprocessing of large-volume access has been detected (step S1503: PREPROCESSING OF LARGE-VOLUME ACCESS), the attribute changer 371, by the detecting unit 601, determines if the value of the access flag is a value indicative of the CPU of the attribute changer 371 or a release value (step S1504).

If the attribute changer 371 determines that the value of the access flag is a value indicative of the CPU of the attribute changer 371 or a release value (step S1504: YES), the attribute changer 371 changes the attribute of the task being executed to “access” (step S1505). The attribute changer 371 sets the value of the access flag to a value indicative of the CPU of the attribute changer 371 (step S1506), stops the attribute changer 371 (step S1508), and returns to step S1501. Stopping the attribute changer 371 indicates, for example, bringing the attribute changer 371 to an execution-waiting condition.

If the attribute changer 371 determines that a request to stop is detected (step S1503: STOP REQUEST), the attribute changer 371 proceeds to step S1508. If the attribute changer 371 determines that the value of the access flag is neither a value indicative of the CPU of the attribute changer 371 nor a release value (step S1504: NO), the attribute changer 371 notifies the scheduler 351 (to step S1301) of a request to dispatch (step S1507) and proceeds to step S1508. When the value of the access flag is neither a value indicative of the CPU of the attribute changer 371 nor a release value, the value indicates that another CPU is performing large-volume access.

As described, according to the multi-core processor system, the control program, and the control method, when one CPU is accessing the shared resources and access preprocessing of another CPU with respect to the shared resources is detected, the task being executed at the other CPU is switched to another task. Since this prevents access contention among plural CPUs with respect to shared resources, access arbitration by the arbiter circuit becomes unnecessary. Therefore, the access of one CPU can be sped up and the effective performance of the CPU can be enhanced.

When one CPU is accessing shared resources at a volume that is greater than or equal to the predetermined volume and access preprocessing for access of the shared resources by another CPU is detected, the task being executed at other CPU is switched to another task. Since this prevents access contention at the other CPU when large-volume access is occurring, the effective performance of the multi-core processor system is enhanced.

When one CPU is accessing the shared resources and access preprocessing for access of the shared resources by another CPU is detected, the volume of access is greater than or equal to the predetermined volume and the task being executed in second CPU is switched to another task. Since this prevents contention among plural CPUs in the large-volume access of the shared resources, the effective performance of the multi-core processor system is enhanced.

As described, according to the multi-core processor system, the control program, and the control method, when one CPU is accessing the shared resources and access preprocessing for access of the shared resources by another CPU is detected, the task being executed in the other CPU is stalled. Since this prevents contention among plural CPUs in the access of the shared resources, access arbitration by an arbiter circuit becomes unnecessary. Therefore, access by a CPU can be sped up and the effective performance of the CPU can be enhanced.

When one CPU is accessing the shared resources at a volume that is greater than or equal to the predetermined volume, if access preprocessing for access of the shared resources by another CPU is detected, the task being executed at the other CPU is stalled. Since this prevents contention at the other CPU when large-volume access is occurring, the effective performance of the multi-core processor system is enhanced.

When one CPU is accessing the shared resources, if access preprocessing by another CPU to access the shared resources at a volume of that is greater than or equal to the predetermined volume is detected, the task being executed at the other CPU is stalled. Since this prevents contention among CPUs during the large-volume access of the shared resources, the effective performance of the multi-core processor system is enhanced.

The multi-core processor system, the computer product, and the control method improve the effective performance of the CPU by reducing the time consumed for accessing the shared memory.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multi-core processor system comprising a first core that is of a multi-core processor and configured to:
detect preprocessing for access of shared resources by a second core that is of the multi-core processor excluding the first core, when the first core is accessing the shared resources shared by the multi-core processor; and
switch a task being executed by the second core to another task upon detecting the preprocessing.

2. The multi-core processor system according to claim 1, wherein
the first core detects the preprocessing when the volume of access of the shared resources by the first core is greater than or equal to a predetermined volume.

3. The multi-core processor system according to claim 1, wherein
the first core detects the preprocessing when a volume of access of the shared resources by the second core is greater than or equal to the predetermined volume when the first core is accessing the shared resources.

4. A multi-core processor system comprising a first core that is of a multi-core processor and configured to:
detect preprocessing for access of shared resources by a second core that is of the multi-core processor excluding the first core, when the first core is accessing the shared resources shared by the multi-core processor; and
stall a task being executed by the second core upon detecting the preprocessing.

5. The multi-core processor system according to claim 4, wherein
the first core detects the preprocessing when a volume of access of the shared resources by the first core is greater than or equal to a predetermined volume.

6. The multi-core processor system according to claim 4, wherein
the first core detects the preprocessing when a volume of access of the shared resources by the second core is greater than or equal to the predetermined volume when the first core is accessing the shared resources.

7. A computer-readable recording medium storing a control program that causes a first core of a multi-core processor to execute a process comprising:
detecting preprocessing for access of shared resources by the first core when a second core that is of the multi-core processor excluding the first core is accessing the shared resources shared by the multi-core processor; and
switching a task being executed by the first core to another task upon detecting the preprocessing.

8. A computer-readable recording medium storing a control program that causes a first core of a multi-core processor to execute a process comprising:
detecting preprocessing for access of shared resources by the first core when a second core that is of the multi-core processor excluding the first core is accessing the shared resources shared by the multi-core processor; and
stalling a task being executed by the first core upon detecting the preprocessing.

9. A control method executed by a first core of a multi-core processor, the control method comprising:
detecting preprocessing for access of shared resources by the first core when a second core that is of the multi-core processor excluding the first core is accessing the shared resources shared by the multi-core processor; and
switching a task being executed by the first core to another task upon detecting the preprocessing.

10. A control method executed by a first core of a multi-core processor, the control method comprising:
detecting preprocessing for access of shared resources by the first core when a second core that is of the multi-core processor excluding the first core is accessing the shared resources shared by the multi-core processor; and
stalling a task being executed by the first core upon detecting the preprocessing.
